(19) United States
(12) Patent Application Publication
(10) Pub. No.: US 2021/0201325 A1
(43) Pub. Date: Jul. 1, 2021

(54) SMART SPENDER CUSTOMER SERVICE SYSTEM AND METHOD

(71) Applicant: Capital One Services, LLC, McLean, VA (US)

(72) Inventors: Anthony REYNOLDS, Richmond, VA (US); Eric K. BARNUM, Midlothian, VA (US)

(73) Assignee: Capital One Services, LLC, McLean, VA (US)

(21) Appl. No.: 16/731,480

(22) Filed: Dec. 31, 2019

(51) Int. Cl. G06Q 20/42; G06Q 40/02; G06Q 20/32; G06Q 20/40; G06Q 20/10; G06F 16/23; G06F 16/9535

(52) U.S. Cl. CPC G06Q 20/42; G06Q 40/02; G06Q 20/3223; G06F 16/9535; G06Q 20/108; G06F 16/2379; G06Q 20/40145

(57) ABSTRACT

A non-transitory computer-readable storage medium storing computer-readable program code executable by a processor to receive via a networking link a transaction query from a mobile device, comprising a customer identifier; to retrieve customer account data associated with the customer, such as a bank account or a credit card account; to determine, from the customer account data, a customer financial profile, including a set of recurring customer expenses and a set of recurring customer income; to generate an advice message for transmission to the customer, where the advice message is based upon the customer financial profile, and further includes a customer query, and to send, via the networking link, the advice message to the mobile device, before completion of the transaction. As such, the advice message may further include a calculated current spending limit, a budget planner message based upon spend information, or a balance projection based upon the spend information.

### TECHNICAL FIELD

Embodiments herein generally relate to automated customer services, and more specifically, to interactive spending systems.

### BACKGROUND

During spending activity, such as routine credit card transaction for purchasing goods or services, a customer may have just a vague appreciation of the customer's current financial “balance sheet,” including how much money may be present in bank accounts or other savings for emergency expenses or other large recurring expenses to take place in the near future or intermediate term future. Accordingly, a credit card or debit card purchase may be routinely completed whenever the account balance of the purchasing card is not exceeded, even when the financial impact of the purchase may be deleterious given other possible expenses to be incurred by the customer.

Known static budgeting tools may allow a customer to forecast financial outlook based upon an idealized monthly projection in order to apprise a customer of the customer's financial status before embarking on a large-scale purchase. Automated checkbook balancing tools also exist to aid a customer in balancing a bank account and viewing historical data. In addition, retirement planning tools exist for projecting the long-term growth of user assets.

The above financial planning tools entail extensive user involvement, or may involve an idealized set of assumptions, leading to less accurate management of a user's assets, including managing of large spending decisions.

### BRIEF SUMMARY

In one embodiment, there is provided a non-transitory computer-readable storage medium storing computer-readable program code executable by a processor to receive via a networking link a transaction query from a mobile device, the transaction query comprising a customer identifier for a customer. The non-transitory computer-readable storage medium storing computer-readable program code may be executable by the processor to retrieve from a database stored on a data store customer account data associated with the customer, where the customer account data comprises one or more of: a bank account and a credit card account. The non-transitory computer-readable storage medium storing computer-readable program code may be executable by the processor to determine, based upon the customer account data, a customer financial profile, where the customer financial profile includes a set of recurring customer expenses and a set of recurring customer income. The non-transitory computer-readable storage medium storing computer-readable program code may be executable by the processor to generate an advice message for transmission to the customer, where the advice message is based upon the customer financial profile, and further includes a customer query, and to send, via the networking link, the advice message to the mobile device, before completion of the transaction. As such, the advice message may further include a calculated current spending limit, a budget planner message based upon spend information, or a balance projection based upon the spend information.

In another embodiment, a method may include receiving an activation signal from a user interface of a mobile device to activate a payment system for a pending transaction at a point of sale device. The method may include transmitting a transaction query from the mobile device over a network link, responsive to the activation signal, where the transaction query comprises a customer identifier associated with a customer account, wherein the customer account is linked to at least one of a bank account and a credit card account. The method may include receiving over the network link before a disposition of the pending transaction an advice message, responsive to the transaction query, where the advice message includes a transaction query, wherein the advice message includes current budget information associated with the customer account. The method may further include displaying the advice message on the device.

In a further embodiment, a device is provided including a processor as well as a user interface, coupled to the processor to receive an activation signal, the user interface comprising one or more of a voice recognition interface, a keypad, a touchscreen, a touchpad, and a biometric interface. The device may include a memory storing instructions executable by the processor to activate a payment system for a purchase application, resident on the device, responsive to the activation signal. The instructions may be executable by the processor to transmit over a network link a transaction query, responsive to the activation signal. The transaction query may include a customer identifier for a customer account associated with the device, and may further include spend information related to the purchase application, wherein the customer account is linked to at least one of: a bank account and a credit card account. The instructions may be executable by the processor to receive an advice message, responsive to the transaction query, and provide the advice message on the device, where the advice message comprises a customer query.

### BRIEF DESCRIPTION OF THE DRAWINGS

FIG. 1 illustrates an embodiment of a system.

FIG. 2 illustrates another embodiment of a system.

FIG. 3 illustrates a further embodiment of a system.

FIG. 4 illustrates one scenario for operation of the system of FIG. 2.

FIG. 5 depicts illustrates still another embodiment of a system.

FIG. 6 illustrates an embodiment of a first logic flow.

FIG. 7 illustrates an embodiment of a second logic flow.

FIG. 8 illustrates an embodiment of a computing architecture.

### DETAILED DESCRIPTION

Embodiments disclosed herein provide a system and techniques to interactively manage a customer transaction, such as a spending transaction to be conducted by transaction card, such as a credit card or debit card.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

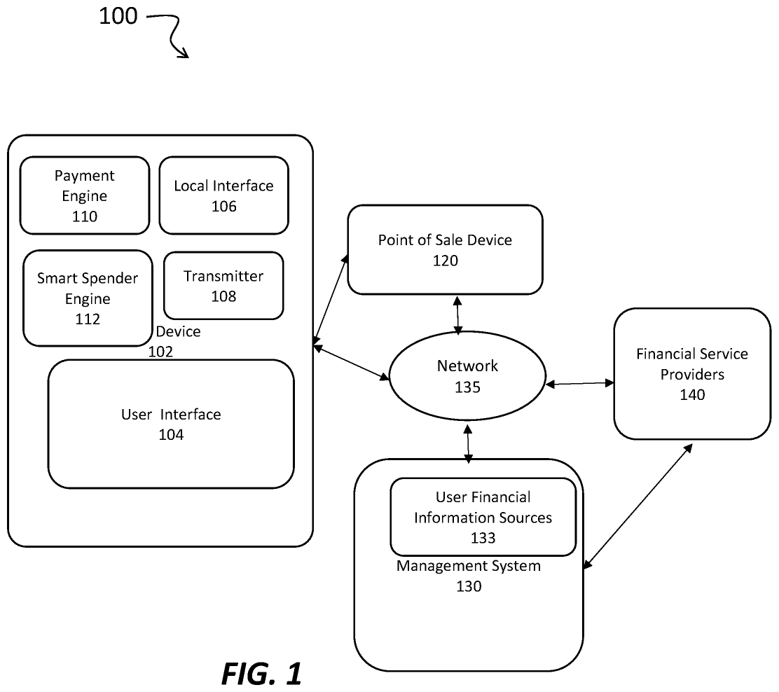

FIG. 1 depicts a schematic of an exemplary system, labeled Smart Spender System 100, consistent with disclosed embodiments. The Smart Spender System 100 may represent an assembly of different systems and/or devices, including user devices, vendor devices or systems, and financial provider systems and/or devices. The embodiments are not limited in this context, however. The smart spender system 100 may function to the disposition of a pending transaction in real time at a point of sale device. The smart spender system may interact with a user in real time to determine whether a pending transaction is to be authorized or canceled. For example, the smart spender system 100 may facilitate customer interaction at the point of a credit card transaction or debit card transaction for determining whether to complete a credit card transaction, for example. As such, the smart spender system 100 may play the function of a transaction interrupt or transaction pause to guide a customer toward transaction completion, transaction cancelation, or transaction change, once the transaction has been initiated.

Shown in FIG. 1 is a user device 102, such as a smart phone or similar mobile device, to name some non-limiting embodiments. In some implementations, the user device 102 may be employed to initiate a transaction card payment, and to complete the transaction card payment, pending interaction with the Smart Spender System 100. The user device 102 may include a user interface 104. Non-limiting examples of a user interface include a voice interface, touchscreen interface, keypad, biometric interface, and so forth. In various implementations, the user device 102 may include a payment engine 110, for facilitating automatic payment from a user account. The payment engine 110 may interact with a local interface 106, such as a near-filed communications chip, to transmit customer and payment information to a point of sale device 120. When a user is to make a purchase at a vendor or other provider associated with the point of sale device 120, the user may place the user device 102 physically proximate the point of sale device 120, within communications range of the point of sale device 120.

The user device may further include a transmitter 108, such as a cellular communications chip, WiFi chip, or other wireless chip, to name a few non-limiting embodiments. The user device may further include a Smart Spender engine 112, whose function is detailed below. In brief, the Smart Spender engine 112 may automatically retrieve and present budget information to the user of the user device 102, at the time of a transaction with the point of sale device 120, to allow the user to complete an informed transaction or terminate the transaction before card payment is completed.

The Smart Spender System 100 may further include a Smart Spender Management System 130, where the operation is detailed below. In brief, the Smart Spender Management System 130 may provide to the customer in real time certain financial information to allow the user to complete a spending transaction, cancel the spending transaction, or redirect the spending transaction to change the source of payment, for example. Financial information provided to the user may include current budget information to help inform the soundness of a transaction card purchase being made at the point of sale device 120. For example, this current budget information may be provided to the customer in response to a transaction query received from the user device 102. In some embodiments, the Smart Spender Management System 130 may include one or more sets of stored information related to a customer, such as the user of the user device 102. This information is depicted as user financial information sources 133. Such information may be periodically updated in the Smart Spender Management System 130, and may be provided to the user device 102 upon occasion, such as when receiving a query from the user device 102. As an example, the User Financial Information Sources 133 may include available balances on credit lines associated with user device 102, a checking account balance associated with user device 102, cash on hand (in some cases, this information may be provided in real-time from user device 102), and so forth.

As detailed in embodiments below, operation of the Smart Spender System 100 may not affect the “round trip time” of authorization networks for authorization of purchases. In existing smart phone payment systems, an authorization network round trip timer starts when a device such as a smart phone transmits payment card information, such as credit card information to a payment terminal. Similarly, in the present embodiments a round trip timer may also start when the credit card information is transmitted. As detailed below, when a user begins to interact at a point of sale device, the smart spender system 100 may have as many real time interactions with the payor (user) as is necessary to ensure the payor makes an informed choice. Such a real time dialog may continue for seconds or minutes—as long as the customer (user) is interacting with the smart spender system 100. Accordingly, in various embodiments, only after a payment choice is made does the smart spender system 100 act to send card information to a payment terminal.

The Smart Spender System 100 may also be linked to or may include a set of financial service providers, shown as the Financial Service Providers 140, which set may include credit card issuers, debit card issuers, commercial banks, commercial lenders, and so forth. The embodiments are not limited in this context. In some implementations, the Smart Spender Management System 130 may form part of Financial Service Provider associated with a user or customer of the user device 102.

In the topology depicted in FIG. 1, the user device 102 may be linked to Smart Spender Management System 130 via a network 135, and may further be linked to the Financial Service Providers 140 via network 135, where the network 135 may represent one or more communications networks. Additionally, the point of sale device 120 may be linked to the Spender Management System 130 and the Financial Service Providers 140 via network 135. During a transaction performed between the user device 102 and Point of Sale Device 120, real-time communications may take place between any of the entities shown in FIG. 1.

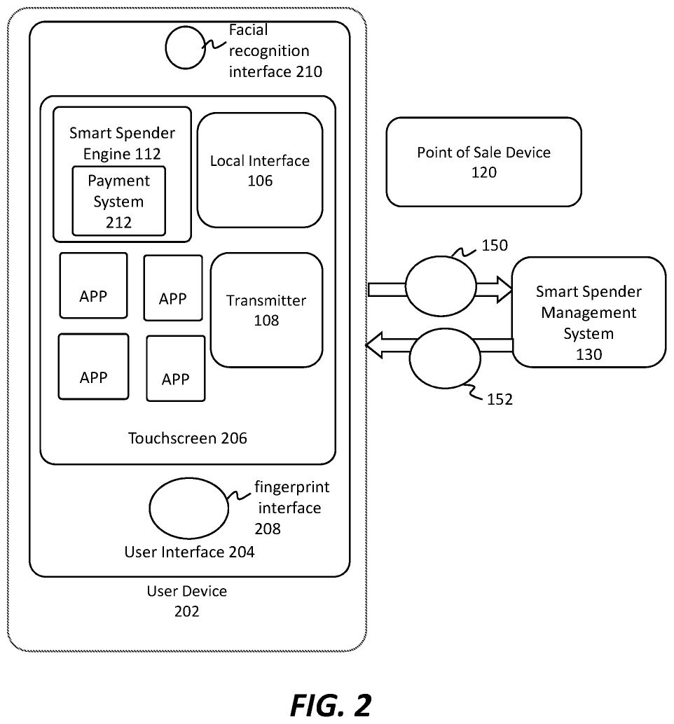

FIG. 2 presents one example of a user device 202, according to further embodiments of the disclosure. In this example, the user device 202 includes a user interface 204, which interface may include a multiplicity of interfaces, including a touchscreen 206, a fingerprint interface 208, facial recognition interface 210, to list some examples. The smart spender engine 112 may be linked to or may include a program, algorithm, or other component facilitating automatic payment at a point of sale. This entity is shown as payment system 212 and may function similarly to known payment systems to provide payment information to a vendor, such as via the local interface 106.

As an example, when the user device 102 is placed proximate the point of sale device 120, the payment system 212 may be activated by receiving an activation signal from the user interface 204. In some embodiments, the activation signal may be generated by the performing of multiple operations. For example, the activation signal may be generated by the press of a button (not separately shown) on user interface 204, as well as personal identification operation, such a depressing of the fingerprint interface 208 or using facial recognition interface 210. In one example, the button may be an icon displayed on touchscreen 206, and associated with Smart Spender engine 112. For example, the button may appear as “Smart Spender” icon on touchscreen 206.

In accordance with some embodiments of the disclosure, after the payment system 212 is activated, payment information, such as credit card information associated with the payment system 212, may be provided to the point of sale device 120. At the same time, the Smart Spender engine 112 may automatically send a signal for the user device 102 to transmit a transaction query 150, responsive to the activation signal, and may receive an advice message 152 in return from the Smart Spender Management System 130, described in further detail below. In brief, the transaction query 150 and advice message 152 may be provided in audible form, in the form of text message, through a menu-based interface, or other visual form. The embodiments are not limited in this context. However, according to various embodiments of the disclosure, the providing of payment information from user device 202 to the point of sale device 120 may be delayed until after the transaction query 150 and after the advice message 152. This scenario is illustrated by the payment message 154, which message is sent only after the transaction query 150 is sent and after the advice message 152 is sent.

In one implementation, a user may enroll as a user or Smart Spender customer by supplying information including user identifiable information, such as personal information, as well as account information, savings account information, checking account information, credit card information, debit card information, and so forth. Enrollment may take place, for example, by Web enrollment, telephone enrollment, or other means. This information may be stored by the Smart Spender Management System 130 as user or customer information. The enrollment may thus provide the Smart Spender Management System 130 with links or access to various accounts associated with a user of the user device 102. In turn, the Smart Spender Management System 130 may use any combination of commercially available tools and proprietary tools to integrate the various user accounts to track the account history of these accounts, make various calculations concerning a user's financial status, and make various predictions and/or recommendations to the user.

Returning to FIG. 2, in one embodiment, the transaction query 150 may include a customer identifier for a customer account associated with the user device 202. Thus, the transaction query 150 may identify the customer account of the user, may include password or other information. The transaction query 150 may act as a flag to the Smart Spender Management System 130, indicating that the customer of user device 102 requires financial input from the Smart Spender Management system 130. Thus, when the payment system 212 is activated, the transaction query 150 may automatically be sent to the Smart Spender Management System 130, triggering the advice message 152 to be sent. In different embodiments, the transaction query 150 may or may not include spend information related to a pending transaction at the point of sale device 120, such as an incipient purchase or contemplated purchase to be made at the point of sale device. In some embodiments, the spend information may be the total purchase price of a transaction, or the amount being charged toward a purchase at the present time.

In different embodiments, the advice message 152 may include different types of information, and may require a further response from the user of user device 102, such as an action to complete the pending transaction with the point of sale device 120, to cancel the pending transaction with the point of sale device 120, to redirect payment with the point of sale device 120 to a different payment source, and so forth. As such, the advice message 152 may include at least as part of the advice message 152, a customer query that prompts the customer to respond and/or take further action before the transaction is completed or terminated. As such, the advice message 152 acts to at least temporarily interrupt a pending transaction to provide relevant information for the customer to make a more informed decision regarding completion or termination of the transaction as the case may be.

As detailed below, the Smart Spender Management system employs algorithms that calculate timely financial information for the customer, such as “Money In” and “Predicted Money Out” so that an advice message may be sent to intercept a pending purchase when that pending purchase may jeopardize the customer financial stability. For example, the advice message 152 may be generated, including a customer query, when a pending purchase may create a No-Go situation for a predicted customer expense to take place in the near future. In this manner, the advice message 152 may provide the user with the opportunity to at least consider whether to complete a purchase based upon information detailing a predicted negative consequence of completing the purchase at present.

To provide useful and timely information to the user or customer associated with user device 102, the Smart Spender Management System 130 may generate a customer financial profile that is updated upon occasion, including at the time of receiving the transaction query 150. The customer financial profile may integrate various financial accounts such as the customer's checking account and savings account, including recurrent income, recurrent expenses, other expense history, associated with the financial accounts. Thus, when a customer registers with the Smart Spender Management System 130, or upon periodic updates from the customer, the Smart Spender Management System 130 may access checking accounts and savings accounts of the customer, and other accounts, and analyze the ledgers of such accounts to determine, for example, recurrent pay cycles for the customer, the amount of pay, periodicity, and time of month of pay; recurrent expenses, such as rent payments, mortgage payments, the time of month of such payments, and so forth. The Smart Spender Management System 130 may user this information to calculate a customer financial profile, as detailed below. As such, the customer financial profile may be used to inform the content of the advice message 152, transmitted to the user device 102.

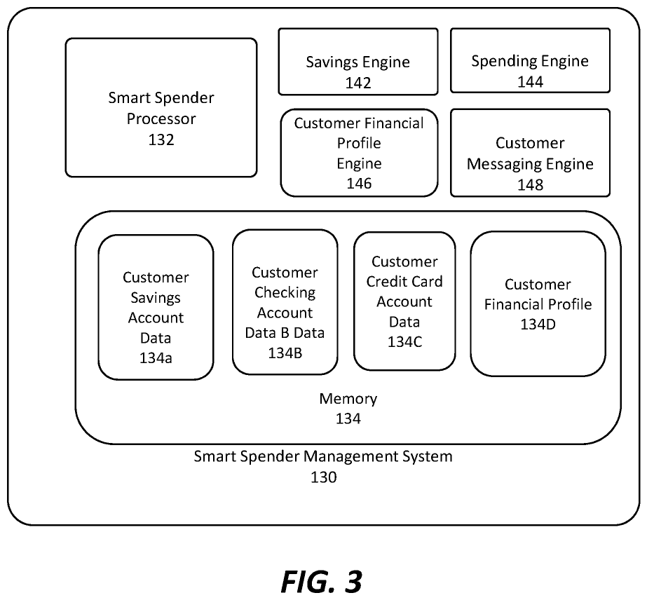

FIG. 3 depicts an embodiment of the Smart Spender Management System 130, including a memory 134 and Smart Spender Processor 132. The Smart Spender Processor 132 in conjunction with the memory 134 may execute a series of operations to provide financial information to a customer, such as the user of user device 102. The Smart Spender processor 132 may include or may operate in conjunction with multiple engines, performing routines or algorithms to assist a customer in real-time in spending decisions at a point of sale (point of purchase), for example. A savings engine 142 may calculate, store, and update savings information related to the customer of user device 102. The savings information may be based upon customer savings account data 134a, stored in memory 134. A savings engine may calculate, store, and update savings information related to the customer of user device 102. The savings information may be based upon databases, stored in one or more data stores, such as customer savings account data 134a, customer checking account data 134B and/or customer credit card account data 134C, stored in memory 134. These databases may in turn be updated periodically by linking the financial service providers 140, shown in FIG. 1. Likewise, a spending engine 144 may calculate, store, and update spending information related to the customer of user device 102. The spending information may again be based upon databases, such as customer savings account data 134A, customer checking account data 134B and/or customer credit card account data 134C, stored in memory 134.

A customer financial profile engine 146 may employ the various databases of memory 134 to generate various information for a customer of user device 102, including determining and updating a customer financial profile 134D. In some embodiments a customer financial profile may be determined by summing various quantities compiled by the Smart Spender Management system 130. In one particular embodiment, the customer financial profile may be determined by calculating a quantity equal to A+B−C−D, where A represents a current total available balance for the customer, B represents a recurrent new income amount for the customer, C represents a total of non-priority expenses, and D represents a total of priority expenses, wherein A, B, C, and D are determined at least in part from the various bank account databases, the credit account database (see memory 134) or a combination of the bank account and credit card databases.

In one example, the quantity A may be determined from a sum of A1+A2+A3, where—A1 represents Cash Balance, A2 is Savings Balance, and A3 is Credit Balance. In one implementation, the cash balance A1 may be provided as a current cash balance from the user device to the Smart Spender Management system 130 at the time of a spending transaction. In some embodiments, the savings balance A2 may represent a sum of current balance in various bank accounts, such as the sum of balances in checking accounts and savings accounts. In some implementations, the Smart Spender Processor 132 may employ known algorithms to determine non-priority expenses C, such as coffer purchases, and priority expenses D, such as rent payments, based upon query of credit card accounts, savings accounts, or checking accounts.

In accordance with various embodiments, the sum of A+B−C−D may be calculated for any given period, such as monthly, bimonthly, and so forth. The Smart Spender Management System 130 may update the customer financial profile intermittently, periodically, on a regular basis, or upon demand. In one example, the customer financial profile may be updated daily to generate a true daily profile. As an example, the true daily profile may represent the sum of A+B−C−D, or similar quantity, updated daily. In this manner, the update cycle to generate the customer financial profile from the accounts and cash on hand takes place frequently enough to provide valuable information to a user or customer, when a transaction query is received at the time of purchase. Thus, in one example, a user may need to supply just a value for cash on hand in a transaction query for the Smart Spender Management System 130 to rapidly update the customer financial profile and provide timely information to the user device 102 after receiving the transaction query.

Because of the integration of the Smart Spender Management system 130 with financial sources, such as a customer checking account, savings account, and credit account, the customer financial profile may be challenged for additional unplanned expenses to build a more accurate budget for the customer, including taking into account unplanned expenses. Accordingly, a customer messaging engine 148 may generate the advice message 152 to provide to the customer at user device 102 various information, options or suggestions on how to proceed at the point of a sale. In various embodiments, the advice message may include a set of current budget information associated with a customer account, where the set of current budget information includes a calculated current spending limit, a budget planner message based upon spend information, or a balance projection based upon the spend information. In particular, in addition to providing information, the advice message 152 may include a customer query that requires user response. For example, the advice message 152 may provide clues about the purchase being attempted, such as: “You can spend this much money freely. Continue?” Other examples of a customer query that may form at least part of an advice message include provision of a menu of options for the customer. For example, the advice message 152 may include within or may trigger the display of a query such as: 1) “Given this transaction will prevent you from making your rent payment in 4 days, would you like to: a) Pay Anyway; b) Cancel Transaction; c) Pay from Savings; d) Pay from Credit Card ending *1234; e) You qualify for a store credit card offer! Select this to get a 10% discount on this purchase.” The embodiments are not limited in this context.

The user of user device 102 may then opt to complete a transaction at the point of sale device 120 if the amount of money to freely spend falls below the purchase amount, for example. The user may transmit an authorization message at the user interface 204, such as pressing a “Yes” button within a purchase application, such as payment system 212.

Alternatively, the user may generate a decline message at the user interface 104, if the cost of the purchase to be made seems excessive in view of the amount of money to be freely spent, as indicated by the advice message 152. For example, the user may press a “No” button on user interface 204, in in response to the advice message 152, indicating not to continue, whereupon the payment system 212 is deactivated, and no charges are made to point of sale device 120.

The advice message 152 may provide various levels of detail and sophistication. For example, the advice message may read “You can't spend this much today, but you can put the purchase on a credit card and subsequently afford the $20/month change to your minimum payment. Continue?” Again, the user may respond by selecting one of the “Yes/No” buttons. Another example of an advice message 152 provided by the Smart Spender Management System 130 is: “If you spend this much, next month you will be in the hole by $573. Continue?”

In addition to providing immediate input to a customer regarding the customer financial profile at the time of purchase, according to various embodiments, the time frame for probing the customer financial profile may be varied. For example, in some embodiments, upon receiving a transaction query, the Smart Spender Management System 130 may automatically tailor an advice message according to different predetermined time limits from the present.

The ability to challenge a customer budget for different time periods allows the customer to make more informed decisions, whether that challenge is to allocate sufficient resources for rent due in the next month, to save for a vacation in 3 months' time, to buy a new car next year, or even to adhere to a retirement plan, where retirement takes place 20 years hence. The immediacy of the feedback to the user device 102 at various instances, such as the time of any given contemplated purchase, allows the customer to more specifically answer the general questions, such as: “Do I actually have as much Money Right Now as I think I do?” and to complete or terminate an incipient purchase accordingly.

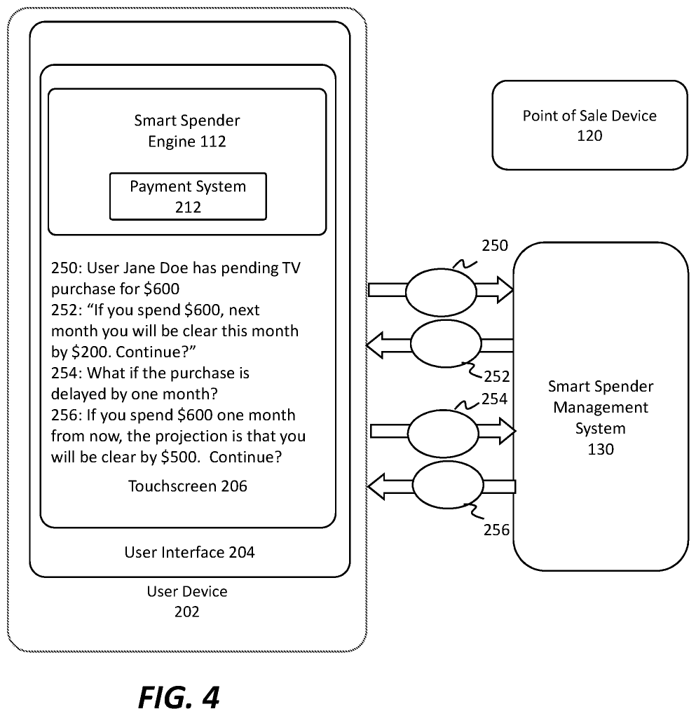

In accordance with various embodiments, the Smart Spender Management system 130 may have as many interactions as necessary with the customer, such as user of user device 102, to ensure the payor makes an informed choice. For example, and referring to FIG. 4, there is shown an exemplary smart spender interaction. In FIG. 4, a first transaction query is shown, message 250. For example, the user of user device 102 activates the payment system 212, as generally described above. In one implementation, the user may manually supply information at the user interface 204 indicating the price of the incipient purchase, such as through text, or by verbal communication. In another implementation, the price of the incipient purchase is automatically provided within software of the payment system 212 (and Smart Spender Engine 112). In either case, the message 250 may convey the information “User Jane Doe has pending TV purchase for $600.” In return, the Smart Spender Management System 130 may return the advice message, shown as message 252: “If you spend $600 today you will be clear this month by $200. Continue?” In the scenario of FIG. 4, the user may by undecided upon receiving the message 252 as to how to proceed. Accordingly, during a communication session (“call”) with Smart Spender Management System 130, the user of user device 202 may send a second message, shown as message 254: “What if the $600 purchase is delayed by one month?” In response, the Smart Spender Management System 130 may return a second advice message, shown as message 256: “If you spend $600 one month from now, the projection is that you will be clear by $500 at that time. Continue?” In one example, the user may select “Yes” and the purchase may be automatically completed, while in another example, the user, acting more conservatively, may select “No”, and the transaction may be canceled. At the same time, in different embodiments, the communication session with Smart Spender Management system 130 may be terminated, either automatically, or by user selection on the user device 202. Thus, a “dialog” between user device 202 and Smart Spender Management System 130 may continue in some cases for minutes—as long as the customer is interacting with the Smart Spender Management System 130. In these examples, not until the payment choice is made, will the smart spender algorithm, running on Smart Spender Engine 112 send the card information to the point of sale device 120.

Notably, in the above embodiments, the authorization process for completing a payment at an authorization network (not separately shown) may not be affected by the user interaction with the Smart Spender Management System 130. In other words, in the present embodiments, as well as in known smart phone payment systems, the “round trip time” between a point of sale device and authorization network starts when the smart phone transmits credit card or debit card information to the point of sale device. Said differently, the interaction between a user device and Smart spender management system 130 takes place before the user device transmits card information.

According to further embodiments of the disclosure, the Smart Spender Management System 130 may store additional information, to more specifically target and manage spending behavior. For example, the user may supply vendor-specific information to be stored by the Smart Spender Management System, specifying, for example, providers or vendors to be targeted for extra scrutiny during a pending transaction. As an example, after the payment system 212 is activated for a pending purchase with a merchant XYZ.com, and a transaction query is sent from the user device 202 to the Smart Spender Management System 130, an advice message may be returned to the customer at user device 202, stating: “Are you sure you want to buy from XYZ.com, you mentioned you wanted additional guardrails around purchases from this company.”

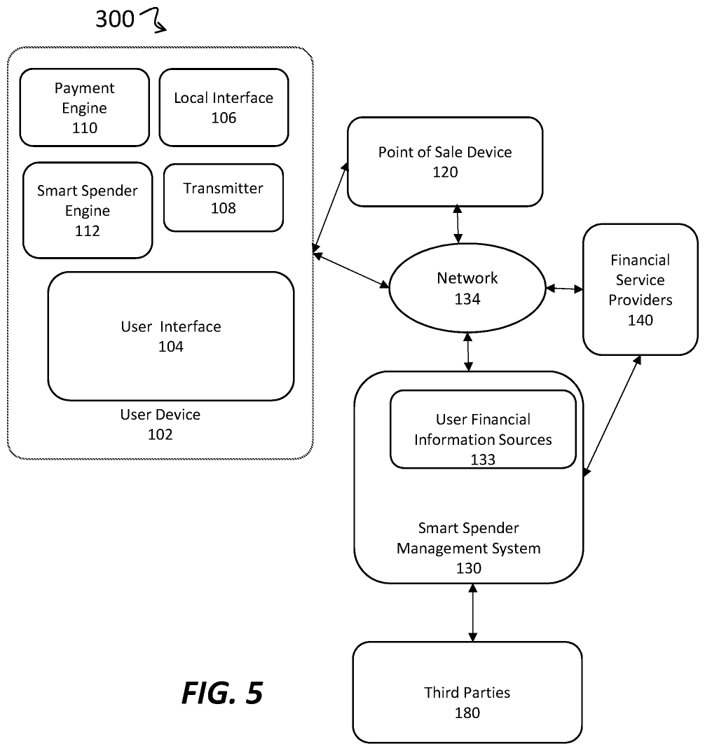

In accordance with additional embodiments of the disclosure, the Smart Spender Management System 130 may be linked to additional parties in order to manage spending decisions. FIG. 5 shows an additional arrangement, system 300, where the Smart Spender Management system 130 is coupled to third parties 180. For example, during registration with the Smart Spender Management system 130, a user may supply third party information, including contact information, enabling Smart Spender Management system 130 to communicate with additional parties to query and to retrieve additional information related to financial status of the user of user device 102. The retrieving of financial information from third parties 180 may take place before, or at the time of a pending purchase, such as at the time of receiving a transaction query from user device 102.

In one scenario, during a call to the Smart Spender Management System 130 from user device 102, the Smart Spender Management System 130 may interact with the user's spouse to ensure the expenditure flagged in the transaction query is something that the family can support. In another scenario, during a call to the Smart Spender Management System 130 from user device 102, the Smart Spender Management System 130 may interact with the user's friends in the manner of a “spending buddy” to help the user of user device 102 to gain control of spending habits.

In accordance with further embodiments of the disclosure, the Smart Spender Management System 130 may retrieve, store, and/or analyze vendor-specific information to identify to the user alternative payment sources for a pending purchase. For example, gift card information or rewards points information provided by various companies may be stored in memory 134 or otherwise identified by the Smart Spender Management System 130. At the time of purchase by a credit card, the Smart Spender Management System 130 may suggest or direct the using of rewards points or the gift cards, where the user may have been unaware of such payment options.

In additional embodiments of the disclosure, the Smart Spender Management System 130 may be employed to guide check-payment activity of a customer, such as the user of user device 102 or user device 202. In one example, the user may initiate check payment to pay a bill according to known procedures where the consumer sends the check to the payee, and the payee begins redemption of the check. The check that is written by the consumer may be for a checking account registered with the Smart Spender Management System 130, and associated with the user device 102 or user device 202. In accordance with some embodiments, when the payee's bank presents the check to the customer checking account for release of funds, the Smart Spender Management System 130 may flag the transaction, and direct an advice message to the user device 202, for example. The advice message may provide the user of user device 202 with alternatives to direct payment of the funds from alternate sources, instead of the checking account. For example, the user of user device 202 may designate payment of funds to satisfy the check from other bank accounts or financial accounts of user device 202 that are stored in memory 134 of Smart Spender Management System 130. Payment may then be sent to the payee's bank from the designated financial account.

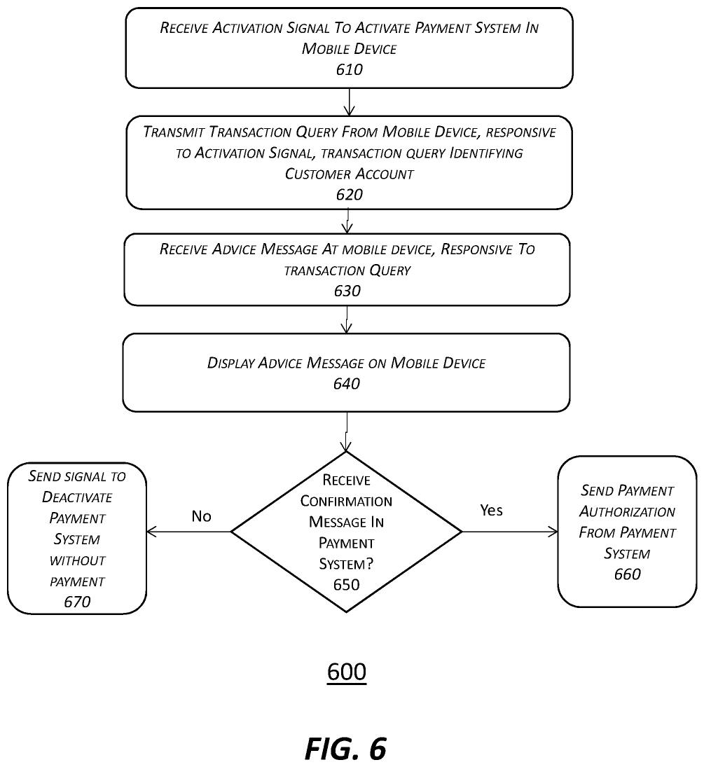

FIG. 6 illustrates an embodiment of a logic flow 600. The logic flow 600 may be representative of some or all of the operations executed by one or more embodiments described herein. Embodiments are not limited in this context. At block 610, an activation signal is received to activate a payment system in a mobile device. The payment system may be arranged to automatically link payment at a point of sale device to a user financial account associated with the mobile device. In some embodiments, the activation signal may be provided by user input at a user interface of the mobile device.

At block 620, a transaction query is transmitted from the mobile device in response to receipt of the activation signal. The transaction query may include information identifying a customer account, where the customer account provides customer account data from multiple financial accounts associated with the user of the mobile device. In some variants, the transaction query may further include information, such as the amount of a payment to be made by the payment system to the point of sale device.

At block 630, an advice message is received at the mobile device, responsive to the transaction query. The advice message may include current budget information derived from the customer account data.

At block 640, the advice message is displayed on the mobile device.

At decision block 650, if a confirmation message in the payment system indicates YES, the flow proceeds to block 660, where payment authorization is sent from the payment system. If the confirmation message indicates NO, the flow proceeds to block 670, where a signal is sent to deactivate the payment system, without payment to the point of sale device.

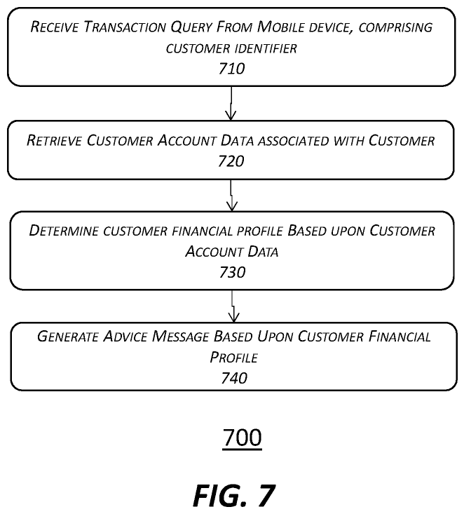

FIG. 7 illustrates an embodiment of a logic flow 700. The logic flow 700 may be representative of some or all of the operations executed by one or more embodiments described herein. Embodiments are not limited in this context.

The flow starts at block 710, where a transaction query is received from a mobile device, including a customer identifier, identifying a customer account. The customer account may include customer account data from multiple financial accounts associated with the user of the mobile device. In some variants, the transaction query may further include information, such as the amount of a payment to be made by a payment system of the mobile device.

At block 720, customer account data is retrieved, associated with the customer account. Non-limiting examples of customer account data include a current total available balance for the customer from various financial accounts, a recurrent new income amount for the customer, a total of non-priority expenses, and a total of priority expenses, wherein these examples of account data are determined at least in part from various bank account databases, credit account databases, or similar databases.

At block 730, a customer financial profile is determined based upon the account data. According to one non-limiting embodiment, the customer financial profile may be determined by calculating a quantity equal to A+B−C−D, where A represents a current total available balance for the customer, B represents a recurrent new income amount for the customer, C represents a total of non-priority expenses, and D represents a total of priority expenses.

At block 740, an advice message is generated, based upon the customer financial profile. The advice message may in part be further based upon payment information received from the mobile device.

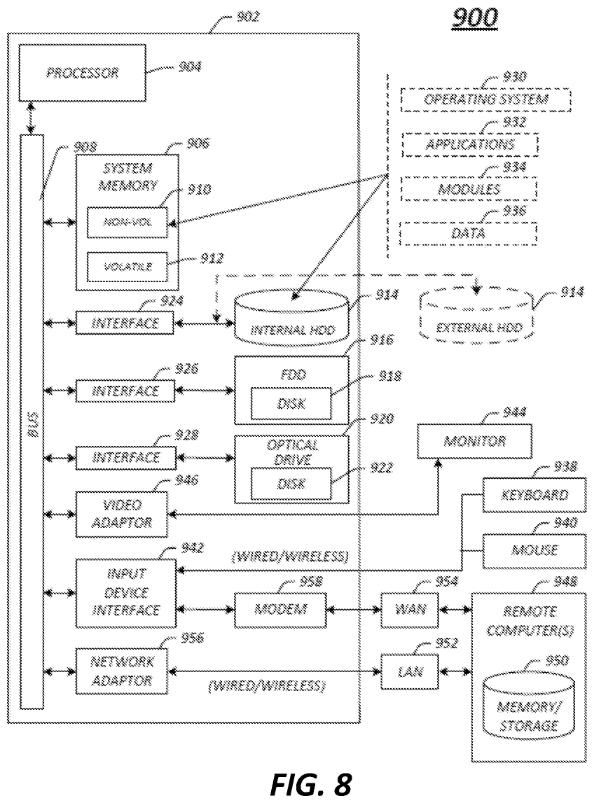

FIG. 8 illustrates an embodiment of a computing architecture 900 comprising a computing system 902 that may be suitable for implementing various embodiments as previously described. In various embodiments, the computing architecture 900 may comprise or be implemented as part of an electronic device. In some embodiments, the computing architecture 900 may be representative, for example, of a system that implements one or more components of the Smart Spender system 100. In some embodiments, computing system 902 may be representative, for example, of the Smart Spender Management system 130, and User Financial Information sources 133 of the smart spender system 100. The embodiments are not limited in this context. More generally, the computing architecture 900 is configured to implement all logic, applications, systems, methods, apparatuses, and functionality described herein with reference to FIGS. 1-7.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 902 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 902.

As shown in FIG. 8, the computing system 902 comprises a processor 904, a system memory 906 and a system bus 908. The processor 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 904.

The system bus 908 provides an interface for system components including, but not limited to, the system memory 906 to the processor 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 906 can include non-volatile memory 910 and/or volatile memory 912. A basic input/output system (BIOS) can be stored in the non-volatile memory 910.

The computing system 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies. The computing system 902 is generally is configured to implement all logic, systems, methods, apparatuses, and functionality described herein with reference to FIGS. 1-7.

The drives and associated computer-readable media provide volatile and/or nonvolatile storage of data, data structures, computer-executable instructions, and so forth. For example, a number of program modules can be stored in the drives and memory units (910, 912), including an operating system 930, one or more application programs 932, other program modules 934, and program data 936. In one embodiment, the one or more application programs 932, other program modules 934, and program data 936 can include, for example, the various applications and/or components of the smart spender system 100, e.g., the payment engine 110, smart spender engine 112, savings engine 142, spending engine 144, customer financial profile engine 146, and customer messaging engine 148.

A user can enter commands and information into the computing system 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computing system 902. In addition to the monitor 944, a computer typically includes other peripheral output devices, such as speakers, printers, and so forth.

The computing system 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computing system 902, although, for purposes of brevity, just a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computing system 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computing system 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computing system 902, or portions thereof, can be stored in the remote memory/storage device 950. It will be appreciated that the network connections shown are exemplary and other means of establishing a communications link between the computers can be used.

The computing system 902 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A non-transitory computer-readable storage medium storing computer-readable program code executable by a processor to:
receive, via one or more networking link, a transaction query from a mobile device to perform a transaction utilizing a first payment account, the transaction query comprising a customer identifier for a customer;
retrieve, from a database stored on a data store, customer account data associated with the customer, the customer account data associated with the first payment account comprising one or more of: a bank account and a credit card account;
determine, based upon the customer account data, a customer financial profile, the customer financial profile comprising a set of recurring customer expenses and a set of recurring customer income for the first payment account;
determine, based on the set of recurring customer expenses and the set of recurring customer income, the first payment account has insufficient funds to pay for the transaction;
generate an advice message for transmission to the mobile device, the advice message based upon the customer financial profile, and further comprising, an indication the first payment account has the insufficient funds to pay for the transaction, a second indication to identify a second payment account to pay for the transaction, and a customer query comprising a menu of options for the transaction, the menu comprising a first option to pay from the first payment account, a second option to pay from the second payment account, and a third option to decline payment;
send, via the one or more networking links, the advice message to the mobile device, before completion of the transaction;
receive, via the one or more networking links and from the mobile device, a message comprising a selection of one of the options, responsive to the advice message; and
transmit, via the one or more networking links, first payment information associated with the first payment account to a point of sale device in response to the selection of the first option;
transmit, via the one or more networking links, second payment information associated with the second payment account to the point of sale device in response to the selection of the second option; or
decline payment to the point of sale device in response to the selection of the third option.

2. The non-transitory computer-readable storage medium of claim 1, the program code executable by the processor to:
update the customer financial profile at least daily to generate a daily profile; and
provide the daily profile to the customer in the advice message.

3. The non-transitory computer-readable storage medium of claim 1, wherein the transaction is to be completed at the point of sale device.

4. The non-transitory computer-readable storage medium of claim 1, the computer-readable program code executable by the processor to determine the customer financial profile to determine a current cash balance, a credit balance, and a savings balance.

5. The non-transitory computer-readable storage medium of claim 4, the computer-readable program code executable by the processor to determine the customer financial profile to subtract the set of recurring customer expenses from a current balance, the current balance comprising a sum of the current cash balance, the credit balance, and the savings balance.

6. The non-transitory computer-readable storage medium of claim 1, the computer-readable program code executable by the processor to determine at least one of: the set of recurring customer income and the set of recurring customer expenses by analyzing an account history of accounts the bank account.

7. The non-transitory computer-readable storage medium of claim 6, the computer-readable program code executable by the processor to predict customer spending based at least in part upon the account history.

8. The non-transitory computer-readable storage medium of claim 1, wherein the transaction query comprises a set of unplanned expenses.

9. The non-transitory computer-readable storage medium of claim 1, the program code executable by a processor to determine the customer financial profile by calculating a quantity equal to A+B−C−D, where A is a current total available balance for the customer, B is a recurrent new income amount for the customer, C is a total of non-priority expenses, and D is a total of priority expenses, wherein A, B, C, and D are determined at least in part from a bank account, a credit card account, or a combination thereof.

10. A method, comprising:
receiving an activation signal from a user interface of a mobile device to activate a payment system for a pending transaction at a point of sale device;
transmitting a transaction query from the mobile device over a network link, responsive to the activation signal, the transaction query comprising a customer identifier associated with a customer account, wherein the customer account is linked to at least one of: a bank account and a credit card account;
receiving, over the network link before a disposition of the pending transaction, an advice message comprising a customer financial profile associated with the customer account, responsive to the transaction query, the advice message comprising a customer query, wherein the advice message includes current budget information associated with the customer account, and the customer query comprising a menu of options for the transaction, the menu comprising a first option to pay from the first payment account, a second option to pay from the second payment account, and a third option to decline payment;
displaying the advice message on the mobile device;
receiving a selection of one of the options of the customer query;
generating a response message comprising the selection of one of the options; and
transmitting the response message from the mobile device over the network link.

11. (canceled)

12. (canceled)

13. (canceled)

14. The method of claim 10, wherein the transaction query comprises spend information, associated with the pending transaction.

15. The method of claim 10, wherein the advice message comprises a projection of expenses and income to be incurred within a predetermined time limit after the transmitting of the transaction query.

16. The method of claim 10, wherein the advice message further includes a calculated current spending limit, a budget planner message based upon spend information, or a balance projection based upon the spend information.

17. A device, comprising:
a processor;
a user interface, coupled to the processor to receive an activation signal, the user interface comprising one or more of a voice recognition interface, a keypad, a touchscreen, a touchpad, and a biometric interface; and
a memory storing instructions executable by the processor to:
activate a payment system for a purchase application, resident on the device, responsive to the activation signal;
transmit a transaction query over a network link, responsive to the activation signal, the transaction query comprising a customer identifier for a customer account associated with the device, and further comprising spend information related to the purchase application, wherein the customer account is linked to at least one of: a bank account and a credit card account;
receive an advice message, responsive to the transaction query;
provide the advice message on the device, the advice message comprising a menu of options for selection via the user interface, the menu comprising a first option to pay from the first payment account, a second option to pay from the second payment account, and a third option to decline payment;
receiving a selection of one of the options of the customer query;
generate a response message comprising the selection of one of the options; and
transmitting the response message over the network link.

18. (canceled)

19. (canceled)

20. The device of claim 17, the advice message comprising a customer financial profile, wherein the customer financial profile is calculated as: A+B−C−D, where A is a current total available balance, B is a recurrent new income amount for the customer, C is a total of non-priority expenses, and D is a total of priority expenses, wherein A, B, C, and D are determined at least in part from the bank account, the credit card account or a combination thereof.
